(19) United States
(12) Patent Application Publication
(10) Pub. No.: US 2004/0100519 A1
(43) Pub. Date: May 27, 2004

(54) Image recording apparatus

(76) Inventors: Noriyuki Kikuchi, Mishima-shi (JP); Hidehiro Watanabe, Tokyo (JP); Megumi Shimizu, Mishima-shi (JP); Yuko Nagata, Mishima-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/410,152

(22) Filed: Apr. 10, 2003

(30) Foreign Application Priority Data
Nov. 26, 2002 (JP) 2002-342669

(51) Int. Cl. B41J 2/165

(52) U.S. Cl. 347/23

(57) ABSTRACT

An image recording apparatus has an image recording unit which records an image on a recording medium by discharging ink from a recording head having a row of a plurality of recording elements. The apparatus includes an environmental condition detection unit which detects environmental conditions, a recording head operation state detection unit which detects the operation state of the recording head, and a control unit which executes maintenance of the recording head based on the detected environmental conditions and detected head operation state.

### CROSS-REFERENCE TO RELATED APPLICATIONS

This application is based upon and claims the benefit of priority from the prior Japanese Patent Application No. 2002-342669, filed Nov. 26, 2002, the entire contents of which are incorporated herein by reference.

### BACKGROUND OF THE INVENTION

1. Field of the Invention

The present invention relates to an image recording apparatus which executes maintenance of a recording head having a row of a plurality of recording elements, and a method of maintaining the recording head of the image recording apparatus.

2. Description of the Related Art

An image recording apparatus, for example, an ink jet recording apparatus is installed in various environments by the user of the apparatus. The temperature and humidity near the recording apparatus are not extremely different in air-conditioned rooms. However, recently, many offices and factories save energy not to disrupt the global environment, and air conditioners are often turned off at weekday nights and on holidays because few or no workers are in the offices or factories. Particularly, at weekends or long vacation, the temperature and humidity often change even in offices and factories in countries and districts with high humidity.

When the environmental conditions of the recording apparatus change extremely, the physical properties such as viscosity of ink change, influencing injection of the ink.

Therefore, there is the need for an image recording apparatus which executes maintenance considering the environmental conditions and the recording head state, and a method of maintaining the recording head.

### BRIEF SUMMARY OF THE INVENTION

According to an aspect of the present invention, there is provided an image recording apparatus comprising a recording head having a row of a plurality of recording elements, an image recording unit which records an image on a recording medium by discharging ink from the recording head, an environmental condition detection unit which detects environmental conditions, a recording head state detection unit which detects the operation state of the recording head, and a control unit which executes maintenance of the recording head based on the detected environmental conditions and detected head operation state.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is schematic diagram showing a mechanical section of an ink jet recording apparatus according to an embodiment of the present invention;

FIG. 2 is a perspective view showing the external view of the ink jet recording head;

FIG. 3 is a view showing the positional relationship between the ink discharge ports of the ink jet recording head;

FIG. 4 is a view showing the relationship between the position of the ink jet recording head and the recording paper feeding direction;

FIG. 5 is a block diagram showing the configuration of the control unit of the ink jet recording apparatus;

FIG. 6 is a view showing an example of a standard value data table;

FIG. 7 is a flow chart showing maintenance by spitting; and

FIG. 8 is a flow chart showing maintenance by purging.

### DETAILED DESCRIPTION OF THE INVENTION

Hereinafter, an embodiment of the present invention will be explained with refereeing to the attached drawings.

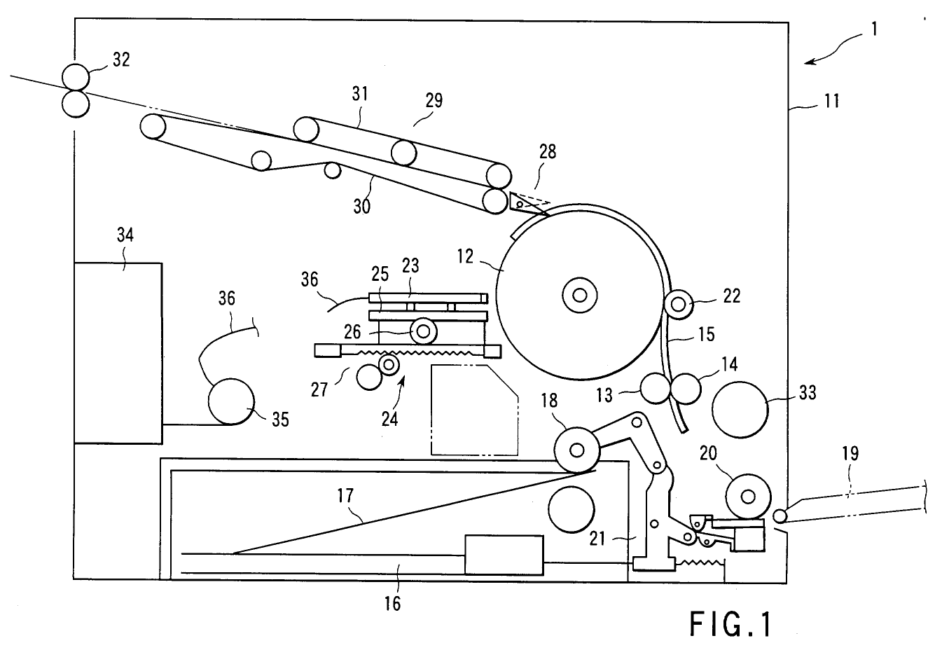

FIG. 1 is schematic diagram showing a mechanical section of an image recording apparatus or an ink jet recording apparatus. In a main unit case 11, a drum 12 which rotates in the arrow direction at a constant peripheral speed is provided. A recording medium, for example, a recording paper 15 supplied through paper feed rollers 13 and 14 is wound around the drum 12.

A paper feed cassette 16 is provided at the bottom of the main unit case 11. The recording paper 15 stacked on a table 17 of the paper feed cassette 16 is taken out one by one with a feed roller 18, and fed to the paper feed rollers 13 and 14. Further, the recording paper 15 fed in manually from a manual feed tray 19 mounted removably is fed by the feed roller 20 to the paper feed rollers 13 and 14. A feed switch unit 21 switches the feeding by the feed roller 18 and the feed roller 20.

A charging roller 22, which attracts the recording paper 15 fed from the paper feed rollers 13, 14 to the drum surface, is arranged opposite to the drum 12. An ink jet recording head 23 having a row of many recording elements is built in a printing mechanism 24. The head 23 can move in the axis of rotation of the drum 12 or in alignment direction of the recording heads. The recording elements are designed to eject ink. They may be either of electro-thermal type or electromechanical type. The ink jet recording head 23 is arranged opposite to the drum 12. Therefore, the recording paper 15 is carried in the direction almost orthogonal to the alignment direction of the recording elements of the ink jet recording head 23 by the rotation of the drum 12.

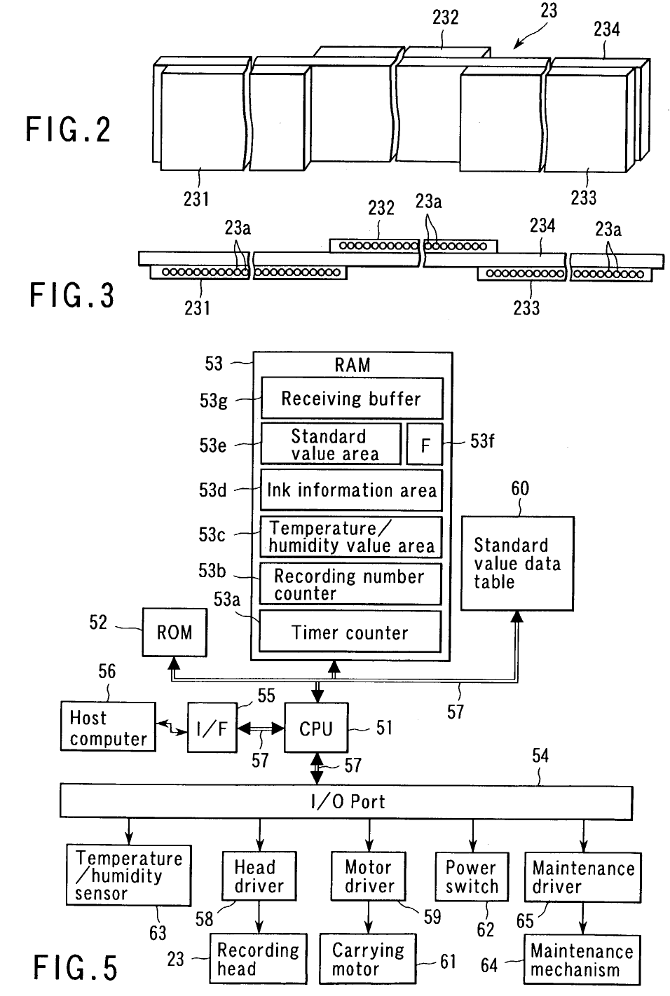

The ink jet recording head 23 comprises, as shown in FIGS. 2 and 3, three head units 231, 232 and 233 having many ink discharge ports 23a aligned at a fixed pitch, which are stuck to both sides of a common base board 234, so that the head unit 232 is located at the middle of one side, and the head units 231 and 233 are located at both ends of the other side. The head units 232, 231 and 232 are positioned, so that all ink discharge ports 23a are aligned at regular intervals in the alignment direction.

The ink discharge ports 23a of the head units 231, 233 and the ink discharge ports 23a of the head unit 232 are not aligned on a straight line with respect to the line direction. By adjusting the ink discharging timing of the head units 231, 233 and 232, it is easy to control to obtain the same printing result when the ink discharge ports 23a of the head units 231, 232 and 233 are aligned on a straight line.

The printing mechanism 24 comprises a reciprocation mechanism 25 with the ink jet recording head 23 mounted thereon, a motor unit 26 having a reciprocating rod and a linear motor, and an advance-retreat unit 27, wherein the advance-retreat unit 27 advances and retreats the ink jet recording head 23 with respect to the drum 12. The motor unit 26 moves the reciprocation mechanism 25 in the rotary axis direction of the drum 12, and reciprocates the ink jet recording head 23 in the rotary axis direction of the drum 12, that is, the recording line direction.

The drum 12 is provided with a separation claw 28 which can be inserted between the drum surface and the recording paper 15. The recording paper 15 is separated from the drum by the separation claw 28, and is ejected to a recording paper ejection mechanism 29. The recording paper ejection mechanism 29 comprises a belt conveyer 30 which contacts the non-recording surface of the recording paper, and a pressing unit 31 which presses the recording paper 15 to the surface of the belt conveyor 30.

An ejection roller 32 is provided in the upper part of the side panel of the main unit case 11. The ejection roller 32 ejects the recording paper carried by the belt conveyor 30 to the outside of the main unit case 11. In the main unit case 11, a main motor 33 which gives a rotational driving force to each unit, an ink cassette 34 which supplies ink, an ink buffer 35 which temporarily stores ink from the ink cassette 34, and ink supply tube 36 which supplies the ink of the ink buffer 35 to the ink jet recording head 23.

The ink jet recording apparatus 1, when printing, takes out the recording paper 15 from the paper feed cassette 16 by the paper feed roller 18, and sends the paper to the paper feed rollers 13 and 14. The paper feed rollers 13 and 14 feed the recording paper 15 to the rotating drum 12, and the paper is wound around the drum. The recording paper 15 is stuck to the surface of the drum 12 by the charging roller 22.

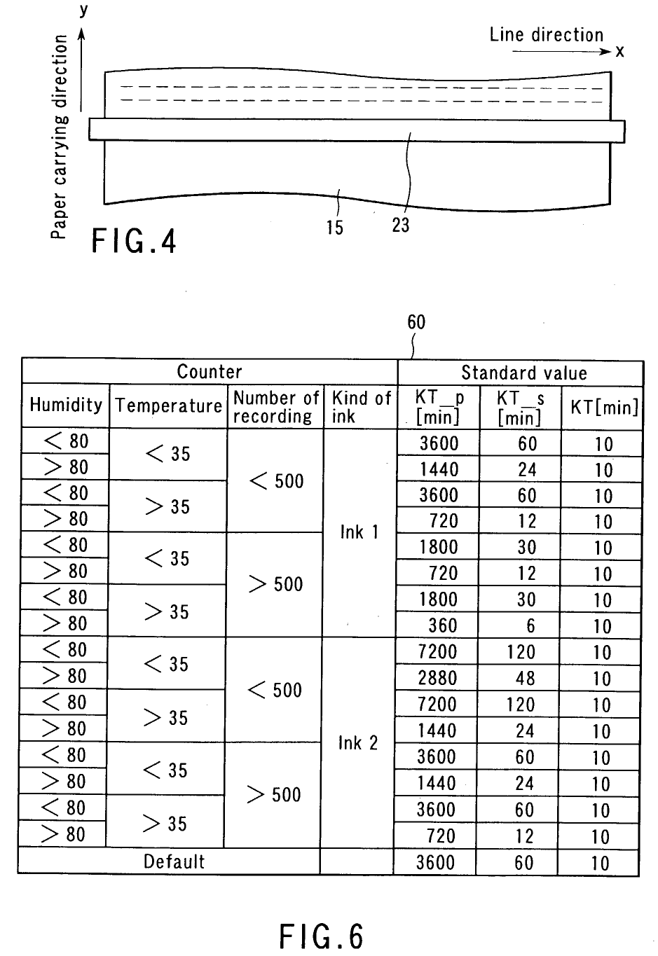

By the rotation of the drum 12, as shown in FIG. 4, the recording paper 15 is moved while rotating to the direction y orthogonal to the line direction x along which the ink discharge ports of the ink jet recording head 23. The ink discharge ports of the ink jet recording head 23 discharges ink onto the recording paper 15 selectively at a fixed timing based on the image signal, and records the image.

The head units 231, 232 and 233 discharge multiple ink drops of the same volume from the discharge ports 23a, and controls the number of the discharged ink drops to realize gradation printing, that is, a so-called multi-drop system is adopted. Thus, when a maximum of three ink drops can be discharged, for example, the printing can be controlled in four gradations including the 0^{th} gradation where no ink is discharged. By making a false intermediate gradation processing, etc for an input image signal, it is possible to get an image signal converted for printing in four gradations of 0-3.

Further, as a maintenance mechanism of the ink jet recording head 23, though not shown in FIG. 1, an ink receiving mechanism is provided in the ink discharging side of the ink jet recording head 23, for the spit maintenance which discharges ink from an ink discharge port to an ink receiver just like printing output, or for the purge maintenance which discharges ink from an ink discharge port to an ink receiver by pressurizing the ink from the ink supply side. The details of the spit and purge maintenance the will be explained later. Further, a cleaning mechanism is also provided for cleaning the area around the ink discharge ports after the spit or purge maintenance is finished.

FIG. 5 is a block diagram showing the configuration of the control unit of the ink jet recording apparatus 1. The control unit is provided with a central processing unit (CPU) 51, a read only memory (ROM) 52, a random access memory (RAM) 53, an input/output (I/O) port 54, and an interface (I/F) 55, as shown in FIG. 5. The CPU 51 realizes various operations such as printing and maintenance by executing the program data to control each part stored in the ROM 52. The RAM 53 is provided with a memory area used for various data processing executed by the CPU 51. The I/O port 54 is connected with each unit described later. The I/F 55 is connected with a host computer 56 via a communication cable.

The CPU 51 is electrically connected to the ROM 52, RAM 53, I/O port 54 and I/F 55 via a bus line 57 such as a control bus, system bus or data bus.

The RAM 53 is provided with a timing counter 53a as a clock to count the time passed after the previous maintenance T_s, T_p (minute)(T_s is the time passed after the spit, and T_p is the time passed after the purge), a recording number counter 53b as a recording number counter to count the number P (sheet) recorded by the recording head 23 after the previous maintenance, a temperature/humidity value area 53c to record the temperature/humidity information from a temperature/humidity sensor 63, an ink information area 53d storing the information about the ink contained in the ink jet recording head 23, a standard value area 53e to store the standard maintenance time KT_s, KT_p (KT_s indicates the spit maintenance, and KT_p indicates the purge maintenance) of the ink jet recording head 23, a flag (F) such as maintenance flags F_s, F_p (F_s indicates the spit maintenance flag, and F_p indicates the purge maintenance flag), and a receiving buffer 53g which temporarily receives the print data from the host computer 56.

The I/O port 54 is connected with a head driver 58 which drives the ink chamber of the ink jet recording head 23, a motor driver 59 which controls a carrying motor 61 for driving the drum 12 and paper feed rollers 13, 14, a power switch 62, and a temperature/humidity sensor 63 which detects the temperature/humidity near the ink jet recording head 23. In this embodiment, the temperature/humidity sensor 63 is provided near the ink jet recording head 23. However, it is permitted to provide the sensor in the proximity of the ink jet recording apparatus 1, for example, the outside of the ink jet recording apparatus 1 in a room or factory, to detect the temperature/humidity near the ink jet recording head. The I/O port 54 is connected with a maintenance mechanism 64 which is driven on maintenance of the ink jet recording head 23, and a maintenance driver 65 which controls the maintenance mechanism 64.

The bus line 57 is connected with a standard value data table 60 for changing each standard value stored in the standard value area 53e of the RAM 53. In the standard value data table 60, as shown in FIG. 6, the maintenance time standard value (spit interval KT_s and purge interval KT_p) and temperature/humidity detection time standard value KT are set, which depend on the temperature/humidity near the ink jet recording head 23, the number of recording made by the ink jet recording head 23 after the previous maintenance, and the kinds of ink. As for the kinds of ink 1 and 2, the ink 1 has higher viscosity than the ink 2. Further, as shown in FIG. 6, regardless of the number of recording and the kind of ink, when the temperature around the ink jet recording head 23 is high, the maintenance time standard value is low. Namely, when the temperature of the ink jet recording head 23 is high, the maintenance time interval is short. Similarly, regardless of the number of recording and the kind of ink, when the humidity near the ink jet recording head 23 is high, the maintenance time interval is short.

Description will now be given on maintenance of the ink jet recording head 23. The maintenance of the ink jet recording head 23 means the process to maintain or restore the functions of the recording head. In the ink jet recording apparatus 1 provided with the ink jet recording head 23, when dust of the recording paper adheres to and clogs the ink discharge port of the ink chamber of the ink jet recording head 23, or when a bubble mixes into the ink discharge port and the surface tension breaks or dust adheres to the discharge port of the ink chamber, the ink chamber fails to discharge the ink or causes an error in the ink discharging timing. Thus, the maintenance is necessary to correct such conditions. The maintenance method is available in spit and purge. The spit extends the ink receiver (not shown) to the discharge port side of the ink jet recording head 23, and discharges the ink to the ink receiver from the discharge ports just like printing output. The purge discharges the ink from the discharge ports by pressurizing the ink from the ink supply side.

Next, description will be given on the spit and purge maintenance methods executed after the power switch of the ink jet recording apparatus 1 is turned on. In either case, the purge is executed in the initial maintenance.

First, the spit maintenance will be explained.

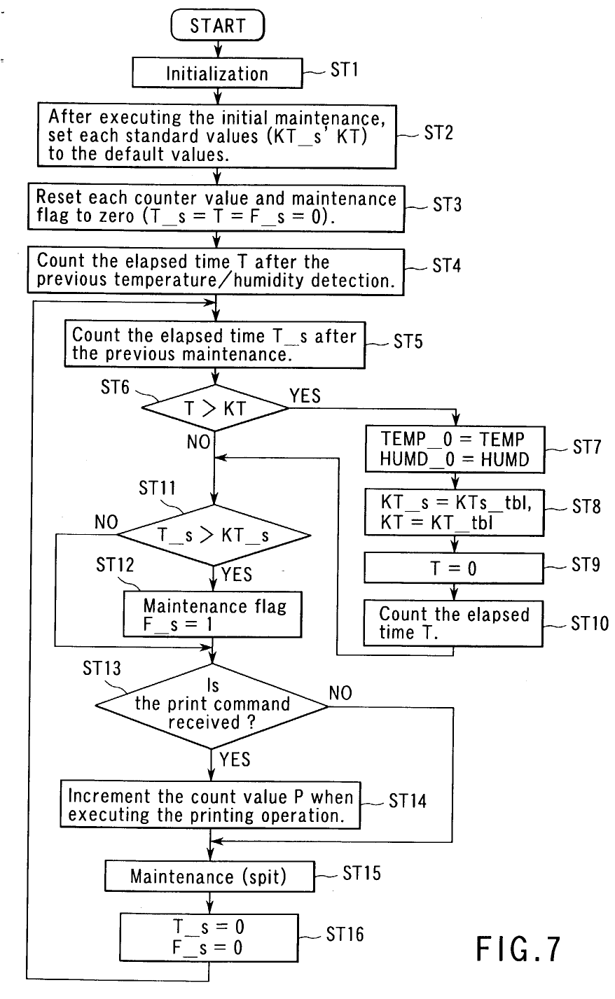

When the power switch 62 is turned on, the CPU 51 executes the maintenance as shown in FIG. 7.

Namely, at first, the CPU 51 executes initialization in ST1. In the initial maintenance, the receiving buffer 53g of RAM 53 and each mechanical unit are initialized.

Next, in ST2, the CPU 51 executes the initial maintenance. The CPU 51 sets the standard values (maintenance standard time KT_s (minute), temperature/humidity detection standard time KT (minute)) in the standard value area 53e of RAM 53, to the default values, that is, the standard values in the standard value data table 60. The initial maintenance means the maintenance upon turning on of the power switch. In the initial maintenance, the purging is executed, that is, the ink receiver (not shown) is extended to the discharge port of the ink jet recording apparatus 23, and the ink is discharged from ink discharge ports to an ink receiver by pressurizing the ink from the ink supply side. It is permitted, in this time, to extend an absorbing member to the discharge port of the ink chamber and absorb the ink from the discharge port by the pressure of the absorbing member.

Then, in ST3, the CPU 51 resets each counter (the counter to count the elapsed time T_s (minute) after the previous spit, the counter to count the elapsed time T (minute) after the previous temperature/humidity detection, and the recording number counter) of RAM 53 to zero, and resets the maintenance flag F_s to zero. In ST4, start counting the elapsed time T (minute) after the previous temperature/humidity detection, and in ST5, start counting elapsed time T_s (minute) after the previous maintenance (spit).

Next, in ST6, the CPU 51 determines whether the elapsed time T after the previous temperature/humidity detection exceeds the temperature/humidity detection standard time KT. When T is larger than TK, the CPU 51 stores the temperature TEMP and humidity HUMD detected by the temperature/humidity sensor 63 in the RAM 53, in ST7. Then, in ST8, the CPU 51 searches the maintenance standard time KTs_tbl and temperature/humidity detection standard time KT_tbl in the standard value data table 60, based on the stored temperature TEMP_{—}0, humidity HUMD_{—}0, the number of recording made by the ink jet recording head 23, and the kind of the ink being used, and store them in the standard area 53e of RAM 53. And, in ST9, the CPU 51 resets the elapsed time T after the previous temperature/humidity detection to zero, and in ST10, starts counting the elapsed time T, and in ST11, determines whether the elapsed time T_s after the previous maintenance exceeds the maintenance standard time KT_s. Even if T_TK in ST6, the CPU 51 determines the same as in ST11.

When T_s>KT_s in ST11, the CPU 51 sets the maintenance flag F_s of the flag 53f in RAM 53 to 1, in ST12. If T_s≦KT_s, in ST11, ST12 is not executed.

Next, in ST13, the CPU 51 determines whether the print command has been received from the host computer 56. When the print command has been received, the CPU 51 executes printing and increments the number of recording made by the ink jet recording head 23 to RAM 53, in ST14, and in ST15, executes the spit maintenance. If the print command has not been received, omit ST14, and execute the spit maintenance, in ST15. Finally, in ST16, the CPU 51 sets the elapsed time T_s after the previous maintenance and maintenance flag F_s to zero.

Next, the purge maintenance will be explained.

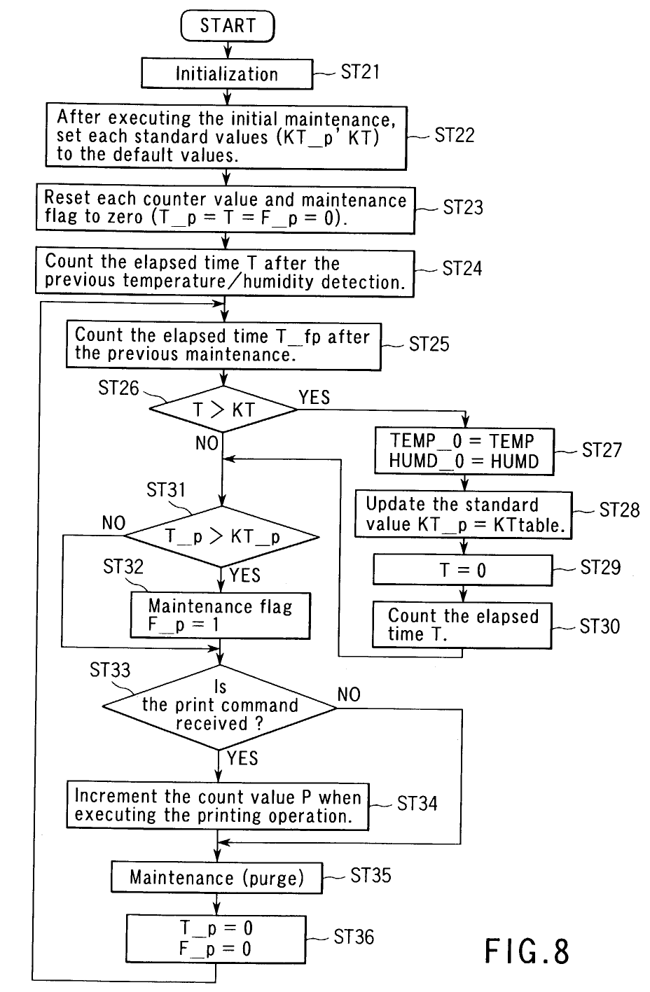

When the power switch 62 is turned on, the CPU 51 executes maintenance as shown in FIG. 8.

Namely, at first, the CPU 51 executes initialization in ST21. In the initial maintenance, the receiving buffer 53g of RAM 53 and each mechanical unit are initialized.

Next, in ST22, the CPU 51 executes the initial maintenance. The CPU 51 sets the standard values (maintenance standard time KT_p (minute), temperature/humidity detection standard time KT (minute)) in the standard value area 53e of RAM 53, to the default values, that is, the standard values in the standard value data table 60. The initial maintenance means the maintenance upon turning on of the power switch. The initial maintenance, the purging is executed, that is, the ink receiver (not shown) is extended to the discharge port of the ink jet recording apparatus 23, and the ink is discharged from ink discharge ports to an ink receiver by pressurizing the ink from the ink supply side. It is permitted, in this time, to extend an absorbing member to the discharge port of the ink chamber and absorb the ink from the discharge port by the pressure of the absorbing member.

Then, in ST23, reset each counter (the counter to count the elapsed time T_p (minute) after the previous maintenance, the counter to count the elapsed time T (minute) after the previous temperature/humidity detection, and the recording number counter) of RAM 53 to zero, and reset the maintenance flag F_p to zero. In ST24, start counting the elapsed time T (minute) after the previous temperature/humidity detection, and in ST25, start counting elapsed time T_p (minute) after the previous maintenance (purge).

Next, in ST26, determine whether the elapsed time T after the previous temperature/humidity detection exceeds the temperature/humidity detection standard time KT. When T is larger than TK, in ST27, the CPU 51 stores the temperature TEMP and humidity HUMD detected by the temperature/humidity sensor 63 in the RAM 53. Then, in ST28, the CPU 51 searches the maintenance standard time KTp_tbl and temperature/humidity detection standard time KT_tbl in the standard value data table 60, based on the stored temperature TEMP_{—}0, humidity HUMD_{—}0, the number of recording made by the ink jet recording head 23, and the kind of the ink being used, and store them in the standard area 53e of RAM 53. And, in ST29, the CPU 51 resets the elapsed time T after the previous temperature/humidity detection to zero, and in ST30, starts counting the elapsed time T, and in ST31, determines whether the elapsed time T_p after the previous maintenance exceeds the maintenance standard time KT_p. Even if T_=TK in ST26, the CPU 51 determines the same as in ST31.

When T_p>KT_p in ST31, the CPU 51 sets the maintenance flag F_p of the flag 53f in RAM 53 to 1, in ST12. If T_p_<KT p, ST32 is omitted.

Next, in ST33, the CPU 51 determines whether the print command has been received from the host computer 56. When the print command has been received, the CPU 51 executes printing and increments the number of recording made by the ink jet recording head 23 to RAM 53, in ST34, and in ST35, executes the purge maintenance. If the print command has not been received, omit ST34, and execute the purge maintenance, in ST15. Finally, in ST36, the CPU 51 sets the elapsed time T_p after the previous maintenance and maintenance flag F_p to zero.

As above explained, the spit and purge maintenance are performed based on the temperature and humidity which are the environmental conditions of the ink jet recording head 23, the number of recording which is the head operation state, and the kinds of ink, that is, the viscosity and other characteristics of ink. When the temperature/humidity sensor 63 is provided in the proximity of the ink jet recording apparatus 1, the environmental conditions conform to the conditions in the proximity of the recording apparatus. Therefore, the ink jet recording apparatus 1 can execute maintenance based on the ambient temperature and humidity, the kind of ink, and the number of recording made by the recording head. Thus, the ink jet recording apparatus 1 can suppress the quantity of ink consumed by the maintenance without degrading the ink discharge performance of the ink jet recording head 23.

It is also possible to proceed simultaneously the spit maintenance shown in FIG. 7 and the purge maintenance shown in FIG. 8. When the spit maintenance and purge maintenance are simultaneously proceeded, it may occur-that the maintenance is executed at the same timing. In this case, the problem can be solved by setting a flag in the RAM 53, for example, to determine the priority of maintenance. Prepare the program which determines the priority of two operations, interrupts one operation when the other is executed, and executes the maintenance of high priority. As for the priority, set the purge prior to the split, for example.

In the above-mentioned embodiment, two methods of maintenance, purge and split, are proposed, but it is permitted to execute a substitutive maintenance by the method of this time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An image recording apparatus comprising:
a recording head having a row of a plurality of recording elements;
an image recording unit which records an image on a recording medium by discharging ink from the recording head;
an environmental condition detection unit which detects environmental conditions;
a recording head state detection unit which detects the operation state of the recording head; and
a control unit which executes maintenance of the recording head based on the detected environmental conditions and detected head operation state.

2. The image recording apparatus according to claim 1, wherein the environmental condition detection unit detects the conditions near the recording head.

3. The image recording apparatus according to claim 1, wherein the environmental condition detection unit detects the temperature and humidity near the recording head.

4. The image recording apparatus according to claim 1, wherein the recording head operation state detection unit counts the number of recording made by a recording head, and detects the operation state of, the recording head.

5. The image recording apparatus according to claim 1, wherein the control unit controls maintenance based on the characteristics of ink used for recording by the recording head.

6. The image recording apparatus according to claim 3, wherein the control unit controls to reduce the time interval for maintenance, when the ambient humidity of the recording head detected by the environmental condition detection unit is high.

7. The image recording apparatus according to claim 3, wherein the control unit controls to reduce the time interval for maintenance, when the ambient temperature of the recording head detected by the environmental condition detection unit is high.

8. A method of maintaining a recording head of an image recording apparatus having an image recoding unit which records an image on a recording medium by discharging ink from the recording head having a plurality of recording elements, comprising:
detecting environmental conditions;
detecting the operation state of the recording head; and
maintaining the recording head based on the detected environmental conditions and detected operation state.

9. The method according to claim 8, wherein the environmental conditions are the conditions near the recording head.

10. The method according to claim 8, wherein the environmental conditions are the ambient temperature and humidity near the recording head.

11. The method according to claim 8, wherein the recording head operation state is the number of recording made by the recording head.

12. The method according to claim 8, wherein the maintenance is executed based on the characteristics of ink used for recording by the recording head.

13. The method according to claim 10, wherein when the detected humidity near the recording head is high, the time interval for maintenance is reduced.

14. The method according to claim 10, wherein when the detected temperature near the recording head is high, the time interval for maintenance is reduced.
